(19) United States
(12) Patent Application Publication
(10) Pub. No.: US 2018/0372054 A1
(43) Pub. Date: Dec. 27, 2018

(54) PORTABLE START-UP POWER SUPPLY

(71) Applicant: SHENZHEN SBASE ELECTRONICS TECHNOLOGY CO., LTD., Guangdong (CN)

(72) Inventor: Zhangsheng CHEN, Guangdong (CN)

(73) Assignee: SHENZHEN SBASE ELECTRONICS TECHNOLOGY CO., LTD., Guangdong (CN)

(21) Appl. No.: 15/535,410

(22) PCT Filed: Jul. 8, 2016
(86) PCT No.: PCT/CN2016/089439

§ 371 Date: Jun. 13, 2017

(51) Int. Cl. F02N 11/12; F02N 11/08; H02J 7/00; H01M 10/0525; H01M 10/42; H01M 10/48

(52) U.S. Cl. CPC F02N 11/12; F02N 11/0866; H02J 7/0021; H02J 7/345; H01M 10/4264; H01M 10/48; H01M 10/0525

(57) ABSTRACT

Disclosed is a portable start-up power supply comprising supercapacitors, lithium-ion batteries, a supercapacitor precharge module, a parallel switch module, a battery management system (BMS), a charging module, a controller, a switch and a car battery bridging and protection module, wherein the controller is connected with the charging module, the BMS, the supercapacitor precharge module, the parallel switch module, the supercapacitors, the car battery bridging and protection module, and the switch; the charging module is connected with the lithium-ion batteries through the BMS; the positive electrode of the lithium-ion battery is connected with the positive electrode of the supercapacitor through the supercapacitor precharge module; the supercapacitors is connected with the car battery bridging and protection module; and the parallel switch module is connected with the lithium-ion batteries and the supercapacitors. The lithium-ion batteries in combination with the supercapacitors realize complementary advantages, so that the present invention has an excellent start-up performance even at an extremely low temperature.

### BACKGROUND OF THE INVENTION

### Technical Field

The present invention relates to a start-up power supply, and more particularly to a portable start-up power supply.

### Description of Related Art

With the continuous improvement of living standards, more and more people are driving cars. But when the battery on a car fails to start up the car engine due to low temperature, unexpected loss of electricity, or damage resulting from other reasons, the current solutions have all been found to have defects or safety and quality hazards. There are some conventional solutions, for example, cables are used for connecting the battery of a failed car to a normal car battery to start up the car, or an external start-up device made from a lead-acid battery is used to start up the car. The former method is obviously not human-oriented because when encountering a situation where a car cannot be started up, the user cannot necessarily quickly find another car for help. In addition, the method is cumbersome to operate, and it is not applicable to ordinary users who are not experienced. Also in terms of the latter solution, the lead-acid battery is bulky and heavy, with a short cycle life, weak dynamic characteristics and higher self-power consumption, and it is not environmentally friendly.

A lithium-ion battery has advantages such as high operating voltage, high specific energy, long charging and discharging life, low self-power consumption and no memory effect, so the use of a lithium-ion battery as a portable car start-up power supply seems to solve these deficiencies. However, the problem is that the performance of low-temperature characteristics of the lithium-ion battery is rather poor, especially when it works in a temperature lower than −30° C., because the electrolytic solution used in a lithium-ion battery is an organic liquid which will become thick and even congeal at a low temperature. At this point, the activities of the conductive lithium salt internally are greatly limited, so the charging and discharging efficiency is very low, which results in a slow or insufficient charging of the lithium-ion battery at a low temperature, and so is the discharging. In this way, in a low temperature environment, the characteristics of a portable start-up device using a lithium-ion battery as a built-in power supply are greatly weakened, so it is hard to instantly release enough power current required for starting up a car. Wherein, generally a low temperature refers to not lower than minus 20 degrees Celsius. At this temperature, the capacity of a conventional battery is only 50˜70% of its nominal capacity. There is also a problem that the current required for starting up a car engine with larger displacement (CCA value or Cold Cranking Ampere) is extremely high, so a lithium-ion battery may cause safety problems due to its own high temperature in the process of discharging high current. And at a low temperature, it cannot discharge high current due to its own reasons. Therefore, its application at a low temperature and as a start-up vehicle is severely limited.

### BRIEF SUMMARY OF THE INVENTION

In view of the above technical problems, the present invention discloses a portable start-up power supply which uses supercapacitors in combination with lithium-ion batteries as a built-in power supply to realize complementary advantages, thus solving the problem where a lithium-ion battery discharges too low of a current at a low temperature and cannot discharge a high current when used for starting up a car.

In this regard, the technical solution of the present invention is:

A portable start-up power supply comprises supercapacitors, lithium-ion batteries, a supercapacitor precharge module, a parallel switch module, a battery management system (BMS), a charging module, a controller, a switch and a car battery bridging and protection module, wherein the controller is connected with the charging module, the BMS, the supercapacitor precharge module, the parallel switch module, the supercapacitors, the car battery bridging and protection module, and the switch; the charging module is connected with the BMS which is connected with the lithium-ion battery; the negative electrode of the lithium-ion battery is connected with the negative electrode of the supercapacitor and the positive electrode of the lithium-ion battery is connected with the supercapacitor precharge module which is connected with the positive electrode of the supercapacitor; the supercapacitor is connected with the car battery bridging and protection module; and the positive electrode of the lithium-ion battery is connected with the positive electrode of the supercapacitor through the parallel switch module. Preferably, the switch comprises a forced start-up switch. The switch may further comprise a capacitor charging switch.

Preferably, the portable start-up power supply is provided with an indicator light and a warning module which are connected with the controller. The indicator light and warning module comprises an indicator light and a buzzer.

Wherein, the lithium-ion battery used as a major part of energy storage undertakes power storage and power output, and meanwhile it can fast charge the supercapacitor, and supply power to other internal components of the device. The charging module is used for connecting an external power supply for charging the lithium-ion battery in the portable start-up power supply. The BMS has the function of over-current, over-voltage and under-voltage protection, and meanwhile it can realize USB and DC power supply output for the endurance of power supply from an external device. The controller can be composed of a programmable MCU unit, being responsible for monitoring and receiving feedback signals from all components so as to realize intelligent judgment and control. The parallel switch module is a switch module which connects the positive electrode of the lithium-ion battery and the positive electrode of the supercapacitor to realize a parallel connection between the two. The supercapacitor precharge module is a charging module which precharges the supercapacitor at low current through a lithium-ion battery and charges it to a set voltage.

The supercapacitor cannot be used for long-term storage of electricity, but for emergency high-current instantaneous discharge; under normal circumstances the supercapacitor does not store any power. Wherein the supercapacitor precharge module precharges the supercapacitor at low current through a lithium-ion battery and charges it to a set voltage, for example, for a four-series lithium-ion battery version with a voltage of 14.8V, the supercapacitor needs to be precharged to a set voltage with a range of 10V<U<13V. The reason why a low-current precharge is required is that the voltage may be 0V when the supercapacitor is not charged. Directly connecting the lithium-ion battery in parallel with the supercapacitor may cause a short-circuit risk of the lithium-ion battery; in addition, the precharged voltage should not be too low, otherwise the process of instantaneous connection of the parallel switch module with the positive electrode of the lithium-ion battery and the positive electrode of the supercapacitor may generate electrical sparks due to over-current which will shorten the working life of the parallel switch module. The technical solution makes good use of the supercapacitor precharge module to precharge the supercapacitor at low current; when the supercapacitor is charged to a preset voltage, the supercapacitor precharge module will send a signal to the controller which sends a signal to turn off the supercapacitor precharge module and simultaneously start the parallel switch module to connect the positive electrode of the lithium-ion battery and the positive electrode of the supercapacitor, to realize the parallel connection between the lithium-ion battery and the supercapacitor; in this case, the output voltage of the supercapacitor and the lithium-ion battery remains consistent and the capacitance is further complemented in place, so that the two output currents realize superposition to compose a hybrid output and the instantaneous discharging current is the sum of both. And then through the connection of the car battery bridging and protection module to the car battery, the module can determine whether or not the ignition output needs to be started.

The car battery bridging and protection module has output ports of positive and negative electrodes used for connecting the ignition clip of the car battery. The module is able to determine whether the car battery is present and whether the ignition clip of the car battery is correctly connected to the corresponding positive and negative electrodes of the car battery. The module also supports the under-voltage, over-current and counter-charge protection of the lithium-ion battery. Preferably, the under-voltage, over-current and counter-charge protection of the lithium-ion battery is composed of a plurality of parallel MOSFETs and diodes.

Supercapacitors (ultracapacitors), also known as electrochemical capacitors (EC), are electrochemical components of energy storage through the polarization of electrolytes developed in the 1970s and 1980s. Different from a conventional chemical power supply, it is a kind of power supply with special characteristics between a conventional capacitor and a battery, and stores the electric energy mainly relying on electric-double-layers and redox pseudo-capacitance charges. However, in the process of energy storage no chemical reaction occurs, and this process of energy storage is reversible, therefore the charging and discharging of a supercapacitor can be repeated for hundreds of thousands of times. The basic principle is consistent with other types of electric-double-layer capacitors in that they both use the activated carbon porous electrode and the double-layer structure composed of electrolytes to obtain extra large capacity.

An outstanding advantage of supercapacitor is fast charging, and 10-second-10-minute charging can reach more than 95% of its rated capacity; it has a long cycle life, and the deep charging and discharging cycles can reach up to hundreds of thousands of times, without the “memory effect”. The capacity of its high-current discharging is strong, with a high energy conversion efficiency and low loss in the process (high-current energy cycle efficiency [symbol] 90%); in addition a supercapacitor has a high power density of up to 300 W/KG-5000 W/KG, equivalent to 5˜10 times that of the battery, with a high safety factor of application. Most importantly, a supercapacitor performs well in its ultra-low temperature characteristics (temperature range: −40° C.˜+70° C.), which makes it extremely suitable for a very low-temperature environment, and it is the one with the largest capacity among the electric-double-layer capacitors having been put into mass production in the world. The characteristics of supercapacitor can be made use of to start up a car.

The voltage of a single supercapacitor in the charging condition is only about 2.8V, so in order to reach the voltage required for starting up a car, such as 12V for a common diesel fuel vehicle, and 24V for trucks or passenger cars, a plurality of supercapacitors need to be connected in series and parallel to achieve the required voltage; the simple use of a supercapacitor to start up a car requires a large number of supercapacitors connected in series and parallel so as to achieve discharging characteristics similar to a lithium-ion battery, and the volume will be greatly increased, thus causing high costs. Another defect is that a supercapacitor cannot store electric energy as long as a lithium-ion battery, so once the power supply of charging is cut off, the stored electric energy will quickly fall off, the voltage will rapidly decline, and the energy will be used up quickly, which is not conducive to storage. This is why a current car start-up device using a supercapacitor as a charging and discharging medium needs to be precharged before starting up a car; the existing method usually uses a car battery to counter-charge a supercapacitor; however, this requires that the car storage battery still has some electric energy and is sufficient to charge the device to a capacitance required for starting up the car engine. This method of operation cannot be used for a car storage battery which has suffered a serious loss of electricity.

The use of this technical solution by way of combining the characteristics of lithium-ion batteries and supercapacitors can achieve complementary advantages, in that their disadvantages in the combination of the two are offset in operation. The portable start-up power supply uses a built-in lithium-ion battery to fast charge a supercapacitor, allowing the supercapacitor to be fast charged without the need for a third-party power supply. A supercapacitor has the characteristics of extremely fast charging, in that it just requires a very short time and consumes a small part of the lithium-ion battery's energy to achieve a required voltage output. In an extremely low temperature condition, the discharging capacity of the lithium-ion battery declines due to the low temperature, that is, the performance of instantaneous discharge of high current degrades, but the lithium-ion battery can still charge the supercapacitor to a required voltage. Before starting up a car, when the controller detects that the user has triggered the supercapacitor charging switch, it will instruct the supercapacitor precharge module to precharge the supercapacitor and charge it to a preset voltage value, and then to send a signal to the controller; the controller controls the shutdown of the supercapacitor precharge module, and meanwhile the parallel switch module connects the positive electrode of the supercapacitor and the positive electrode of the lithium-ion battery; in this case, the lithium-ion battery and the supercapacitor are connected in parallel to form hybrid power which is connected to the car battery through the battery bridging and protection module, so that the use of the strong high-current hybrid power output of the lithium-ion battery and the supercapacitor realizes the emergency starting of the car engine.

The power supply realizes a hybrid power output by means of lithium-ion batteries and supercapacitors in parallel, so that the instantaneous discharging capacity of the supercapacitors and the discharging capacity of the lithium-ion batteries realize superposition to reach a current value required for starting up a car. In an extremely low temperature condition, the high-current discharging capacity of the lithium-ion battery declines; in this case, thanks to the auxiliary discharging of the supercapacitor, the instantaneous current required for starting up a car engine is shared by the supercapacitor partially, thus relieving the burden of the lithium-ion battery and reducing the heat emission of the lithium-ion battery pack, and meanwhile extending the life of the lithium-ion battery pack, which helps achieve multiple purposes.

As a further improvement of the present invention, the supercapacitor precharge module comprises a step-down charging circuit and a supercapacitor voltage detection circuit; wherein the input terminal of the step-down charging circuit is connected with the positive electrode of the lithium-ion battery, the output terminal of the step-down charging circuit is connected with the positive electrode of the supercapacitor, the supercapacitor voltage detection circuit is connected with the output terminal of the step-down charging circuit, and the step-down charging circuit and the supercapacitor voltage detection circuit are connected with the controller; the switch comprises the supercapacitor charging switch which is connected with the controller.

As a further improvement of the present invention, the portable start-up power supply comprises a lithium-ion battery deformation detection sensing module which is connected with the surface of the lithium-ion battery and the controller. Wherein the lithium-ion battery deformation detection sensing module senses the deformation of the cell of the lithium-ion battery and gives feedback to the module. The sensing head of the lithium-ion battery deformation detection sensing module senses the deformation of the surface of the lithium-ion battery. With this technical solution, the lithium-ion battery deformation detection sensing module monitors the safety morphology of the lithium-ion battery; in case of any hazardous conditions detected in the lithium-ion battery, a signal will be instantly sent to the controller to turn off all functions of the device so as to prevent serious consequences such as over-charge burning or explosion and protect the user's personal and property safety.

As a further improvement of the present invention, the portable start-up power supply comprises a temperature detection module, wherein one end of the temperature detection module is connected with the lithium-ion battery and the other end is connected with the controller. With this technical solution, the temperature of the lithium-ion battery is monitored; in case the temperature exceeds a preset value or rises abruptly, the controller will instantly turn off all functions of the device so as to prevent serious consequences such as burning or explosion due to over-charge of the lithium-ion battery and protect the user's personal and property safety.

As a further improvement of the present invention, the portable start-up power supply comprises a USB interface and/or a DC interface, wherein one end of the USB interface and/or the DC interface is connected with a controller, with the other end is connected with the BMS.

As a further improvement of the present invention, the controller comprises an MCU unit. With this technical solution, programming and recording can be realized. Preferably, the model of the MCU is NTMP2014-3. The chip can be programmed and re-recorded.

As a further improvement of the present invention, the lithium-ion battery is a battery pack comprising four or seven single lithium-ion batteries in series. The voltage of a normal lithium-ion battery is 3.7V, so the voltage of the lithium-ion battery pack composed of four single lithium-ion batteries can reach about 14.8V. Preferably, the capacity of the single lithium-ion battery is 3000 mAh. The battery pack can realize high-current discharging in a proper temperature condition for starting up a diesel fuel car with a 12V automotive battery, and it can supply power to a supercapacitor in a low temperature condition for starting up a car. Wherein, the use of four lithium-ion batteries connected in series can be applicable to a 12V diesel fuel car and the use of seven lithium-ion batteries connected in series can be applicable to a 24V truck.

As a further improvement of the present invention, the supercapacitor comprises a supercapacitor pack. Preferably, the supercapacitors comprise a supercapacitor pack composed of a plurality of supercapacitors connected in series and/or in parallel. More preferably, the supercapacitors comprise a supercapacitor pack composed of five supercapacitors connected in parallel and five in series. After the supercapacitors are selected, a target voltage of charging of the supercapacitor should be set based on the rating curve of the supercapacitor. The rated voltage of most of the supercapacitor units is in the range of 2.5V to 3.3V at room temperature, and this rated value drops at a higher temperature. Typically, the set value of the target voltage of charging should be lower than the maximum rated voltage so as to extend the working life of the supercapacitor. The supercapacitor pack can be configured in parallel, in series, or as a combination of serial capacitors connected in parallel. To meet the requirements of energy, multiple serial capacitors will be connected in parallel. For example, the voltage of the single supercapacitor is about 2.8V, with the capacity of 25 F, and the use of five supercapacitors connected in series can realize an equivalent output voltage value of 5×2.8V=14V; however, the capacity is not sufficient to start up a car, so the use of five supercapacitors in parallel can realize a larger capacity to realize higher instantaneous discharging. Wherein, the five supercapacitors in parallel and five in series can be realized by means of a supercapacitor series connected in parallel, wherein each pack of the supercapacitor series is composed of five supercapacitors in series. In this way, the supercapacitor pack is equivalent to the voltage of the lithium-ion battery.

As a further improvement of the present invention, the parallel switch module comprises at least two relays or MOS transistors which are connected in parallel.

As a further improvement of the present invention, the lithium-ion battery deformation detection sensing module comprises at least two deformation sensors which are arranged in array on the surface of the cell of the lithium-ion battery.

As a further improvement of the present invention, it comprises an LED light and a buzzer which are connected with the BMS respectively. In this technical solution, the controller controls the BMS and the BMS controls the LED light so as to realize the ON-SOS-flashing function.

Compared with the prior art, the beneficial effects of the present invention are as below:

With the technical solution of the invention, the lithium-ion batteries can be used in combination with the supercapacitors to realize complementary advantages; the portable power supply can use the built-in lithium-ion battery to fast charge the supercapacitor, and also can charge the supercapacitor to a required voltage under an extremely low temperature. Therefore, the power supply realizes a hybrid power output by means of lithium-ion batteries and supercapacitors in parallel, so that the instantaneous discharging capacity of the supercapacitor and the discharging capacity of the lithium-ion battery realize superposition to reach a current value required for starting up a car. In an extremely low temperature condition, thanks to the auxiliary discharging of the supercapacitor, the instantaneous current required for starting up a car engine is shared by the supercapacitor partially, thus relieving the burden of the lithium-ion battery, and meanwhile extending the life of the lithium-ion battery, which helps achieve multiple purposes. At the same time, the power supply can also charge other portable electronic devices thanks to its multi-functionality.

### BRIEF DESCRIPTION OF THE SEVERAL VIEWS OF THE DRAWINGS

FIG. 1 is a diagram of the circuit module in one embodiment of the present invention;

FIG. 2 is a circuit block diagram of the supercapacitor precharge module according to one embodiment of the present invention;

FIG. 3 is a circuit diagram of the supercapacitor precharge module according to one embodiment of the present invention;

FIG. 4 is a schematic diagram of a combination of the supercapacitors according to one embodiment of the present invention;

FIG. 5 is a circuit diagram of the parallel switch module according to one embodiment of the present invention;

FIG. 6 is a circuit diagram of a solution of the car battery bridging and protection module according to one embodiment of the present invention; and

FIG. 7 is a circuit diagram of the lithium-ion battery deformation detection sensing module according to one embodiment of the present invention.

### DETAILED DESCRIPTION OF THE INVENTION

The preferred embodiment of the present invention is further detailed in combination with the drawings as follows.

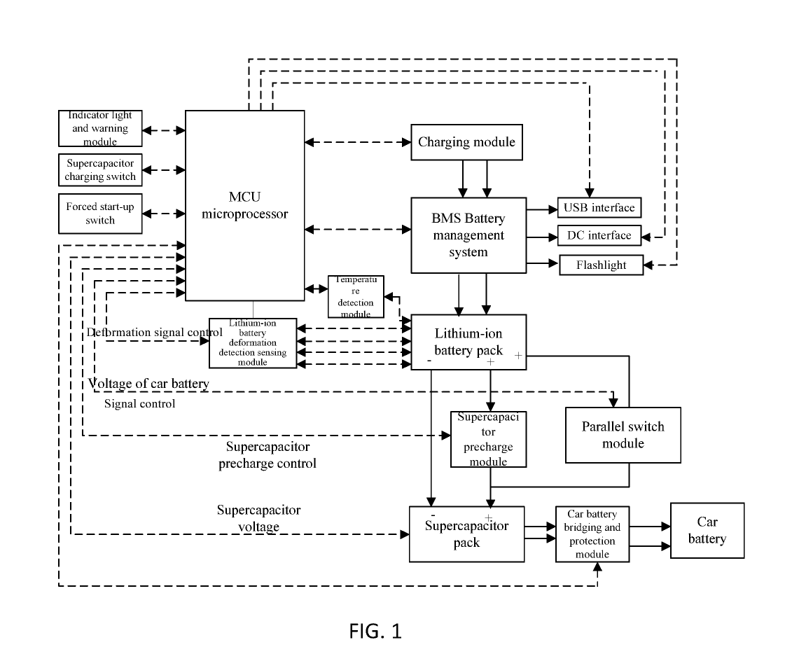

As shown in FIG. 1, a portable start-up power supply comprises supercapacitors, lithium-ion batteries, a supercapacitor precharge module, a parallel switch module, a battery management system (BMS), a charging module, an MCU microprocessor, a switch and a car battery bridging and protection module, wherein the MCU microprocessor is connected with the charging module, the BMS, the supercapacitor precharge module, the parallel switch module, the supercapacitors, the car battery bridging and protection module, and the switch, the charging module is connected with the BMS which is connected with the lithium-ion battery, the lithium-ion batteries are connected with the supercapacitor precharge module which is connected with the supercapacitors, the supercapacitors are connected with the car battery bridging and protection module, and the parallel switch module is connected with the lithium-ion batteries and the supercapacitors. The portable start-up power supply comprises a lithium-ion battery deformation detection sensing module which is connected with the surface of the lithium-ion battery; when the lithium battery deforms, such as a bulge, the sensor will be triggered and send back a signal to the MCU to turn off the entire system; the lithium-ion battery deformation detection sensing module is further connected with the MCU microprocessor. The portable start-up power supply comprises a USB interface and a DC interface, one end of the USB interface and the DC interface is connected with the MCU microprocessor, with the other end connected with the BMS. The switch comprises a forced start-up switch and a capacitor charging switch. The portable start-up power supply comprises an indicator light and warning module which is connected with the MCU microprocessor.

Preferably, the model of the MCU is NTMP2014-3.

The lithium-ion battery is a lithium-ion battery pack, which uses four 3.7V/3000 mAh polymer lithium-ion batteries connected in series to form a 14.8V/3000 mAh lithium-ion battery pack, so that under a proper temperature, it can realize high-current discharging for starting up a diesel fuel car with a 12V car battery.

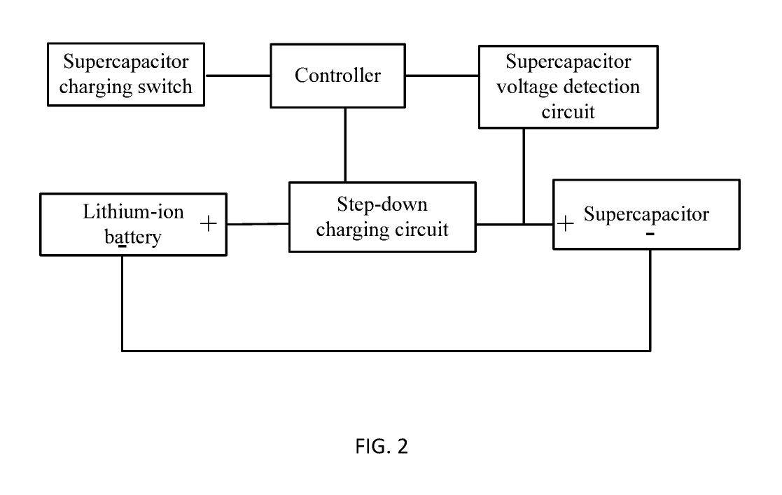

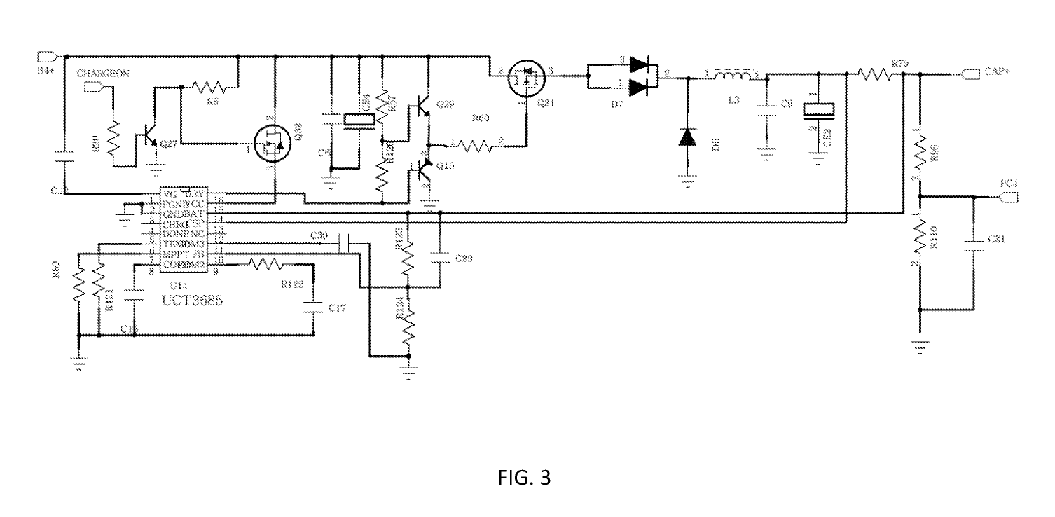

As shown in FIG. 2, the supercapacitor precharge module comprises a step-down charging circuit and a supercapacitor voltage detection circuit; wherein the input terminal of the step-down charging circuit is connected with the positive electrode of the lithium-ion battery, the output terminal of the step-down charging circuit is connected with the positive electrode of the supercapacitor, the supercapacitor voltage detection circuit is connected with the output terminal of the step-down charging circuit, and the step-down charging circuit and the supercapacitor voltage detection circuit are connected with the controller; the supercapacitor charging switch is connected with the controller. The circuit diagram of the supercapacitor precharge module is shown in FIG. 3.

As shown in FIG. 3, the precharge uses a step-down charging mode with a UCT 3685 chip. The UCT 3685 work process is as follows: the IC starts the step-down charging when it is powered on; this is a typical BUCK circuit: Q31 is a PMOS transistor, D7 and D5 are fast recovery diodes, L3 is an inductor, R79 is a current sampling resistor (current formula: ICH=200 mV/RCS: ICH is the charging current (unit: ampere), Rcs is the detecting resistor R79). The FB pin of the UCT 3685 chip is used for detecting the full-charging voltage; when detecting that the supercapacitor's voltage is higher than 12.5V, the charging will stop. Wherein the formula of the full-charging voltage is: V_{BAT}=2.416*(I+R7/R6)+I_{B}*R7, wherein I_{B} is the bias current of the FB pin, typically 50 nA.

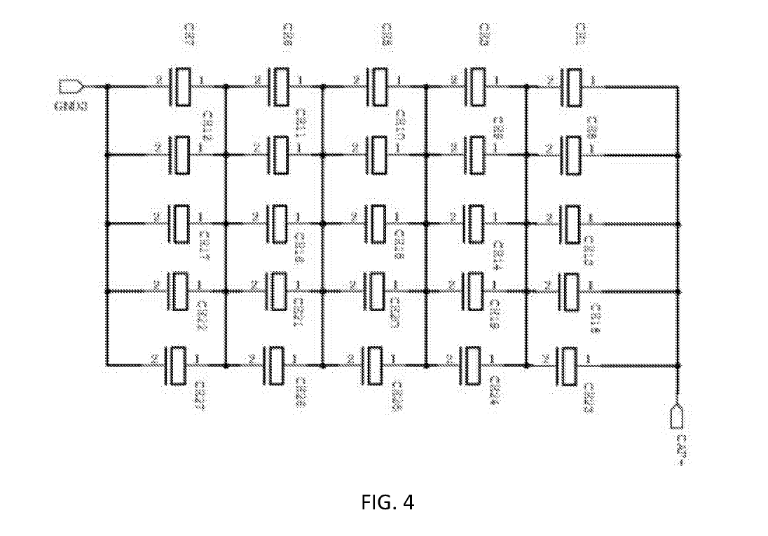

As shown in FIG. 4, the supercapacitors comprise a supercapacitor pack composed of a plurality of supercapacitors connected in series and/or in parallel. In FIG. 4, the supercapacitor pack comprises a supercapacitor pack composed of five supercapacitors connected in parallel and five in series. The voltage of the single supercapacitor is about 2.8V, with the capacity of 25 F; in order to realize a higher instantaneous discharging capacity, it is necessary to use more supercapacitors connected in series based on the required voltage that is realized, for example, the use of five supercapacitors connected in series can realize an equivalent output voltage value of 5×2.8V=14V; however, the capacity is not sufficient to start up a car, so the use of five supercapacitors connected in parallel and in series can realize a larger capacity to realize higher instantaneous discharging. The equivalent capacitance is calculated as follows:

in series: the sum of the reciprocal of each sub-capacitance is equal to the reciprocal of the total capacitance: 1/C1+1/C2+1/C3 . . . =1/C in total;

in Parallel: the sum of each sub-capacitance is equal to the total capacitance C1+C2+C3 . . . =C in total.

For example, five supercapacitors connected in parallel and five in series: the equivalent output voltage is 5×2.8V=14V, and the equivalent capacitance C is 1/( 1/25+ 1/25+ 1/25+ 1/25+ 1/25)×5=25 F.

According to the calculation formula of the supercapacitor's capacitance and discharging time: C=(Vwork+Vmin)*IC*t/(V2work−V2 min), wherein Vwork is the starting voltage of the supercapacitor, Vmin is the cut-off voltage of the supercapacitor, t is the working time, and I is the working current value. For example, assuming Vwork is the supercapacitor's starting voltage of 14.8V, Vmin is the supercapacitor's cut-off voltage of 12.5V, and the instantaneous discharging is required to be completed within 0.1 seconds, then the equivalent IC working current is 575 A; in case the lithium-ion battery can output the current IB of 400 A, this method can realize 975 A-peak instantaneous discharging, which is sufficient to start up a high-power car engine.

The supercapacitor precharge module precharges the supercapacitors at low current through lithium-ion batteries. When it precharges the supercapacitors at low current to a preset voltage, it will realize the direct parallel connection between the lithium-ion batteries and the supercapacitors through the parallel switch module as a hybrid output.

The working principle is:

When the MCU detects that the supercapacitor precharge switch is pressed, the MCU CHARGING outputs a high-level current, the UCT 3685 starts to work, the MCU PC4 starts to detect the supercapacitor's voltage, the indicator light of capacitance flashes; when the MCU PC4 detects that the supercapacitor's voltage is higher than 12.5V (it can be adjusted according to need), the MCU CHARGERON outputs a low-level current, the indicator light of capacitance of the supercapacitor is ON, the UCT 3685 stops working; when the MCU detects that the supercapacitor's precharge is completed, it will send a signal to turn off the supercapacitor precharge module; in case of the correct connection of the ignition clip to the positive and negative electrodes of the car battery, when the car battery bridging and protection module normally determines that the car battery is present, it will send back a normal signal to the MCU microprocessor, and simultaneously the MCU microprocessor will trigger and start the parallel switch module to realize the direct parallel connection between the lithium-ion batteries and the supercapacitors; in this case the lithium-ion batteries will fast charge the supercapacitors at high current and quickly charge it to a voltage value consistent with the lithium-ion batteries; therefore, the use of the strong high-current hybrid power output of the lithium-ion batteries and the supercapacitors realizes the emergency start of the car engine. Since the supercapacitor is only used for instantaneous discharging and is not for the purpose of long-term energy storage, each time the supercapacitor precharge module precharges the supercapacitors until the parallel switch module is started so as to realize a shorter time of the entire process of the parallel connection between the lithium-ion batteries and the supercapacitors; taking the above-mentioned supercapacitor pack composed of five supercapacitors connected in series and five in parallel for example, the time required for charging the supercapacitors to the working voltage of 14.8V is only about 1 minute, and the power consumption of the lithium batteries is less than 3%.

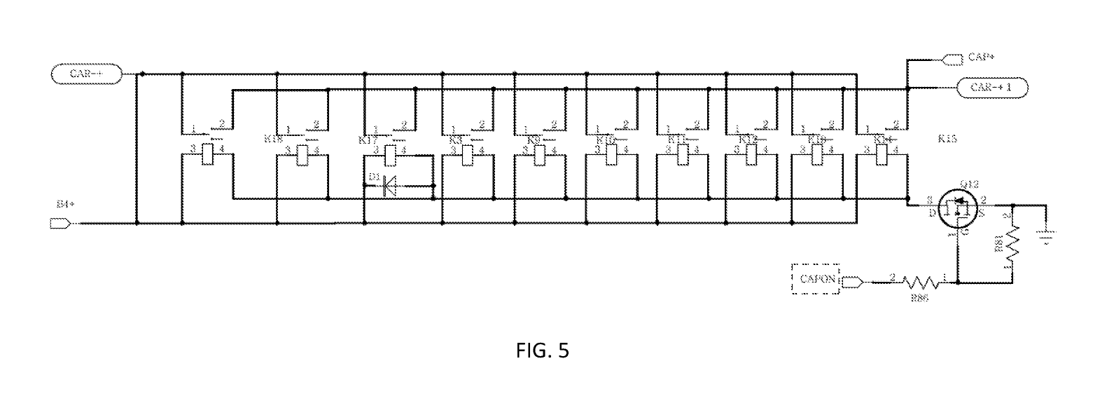

As shown in FIG. 5, the parallel switch module comprises a plurality of parallel relays (K3 K9 K10 K11 K12 K13 K14 K15) used for controlling the lithium-ion batteries to be connected in parallel with the supercapacitors to form hybrid power while realizing that the lithium-ion batteries fast charge the supercapacitors and charge them to the voltage output of the lithium-ion batteries. When the MCU microprocessor detects that the supercapacitors are precharged to the set voltage value, for example, 12.5V given in this embodiment, the MCU microprocessor turns off the supercapacitor precharge module, and meanwhile the CAPON outputs a high-level current; the parallel switch module is turned on, so that the relay is powered on to work, to realize the parallel connection between the lithium-ion batteries and the supercapacitors; the MCU JON pin remains at a high level to start the ignition.

When the precharge of the supercapacitors is completed, the parallel switch module completes the parallel connection between the supercapacitors and the lithium-ion batteries, and forms a hybrid power output. In case of the connection of the car battery bridging and protection module to the car battery, the module can determine whether or not the ignition output needs to be started.

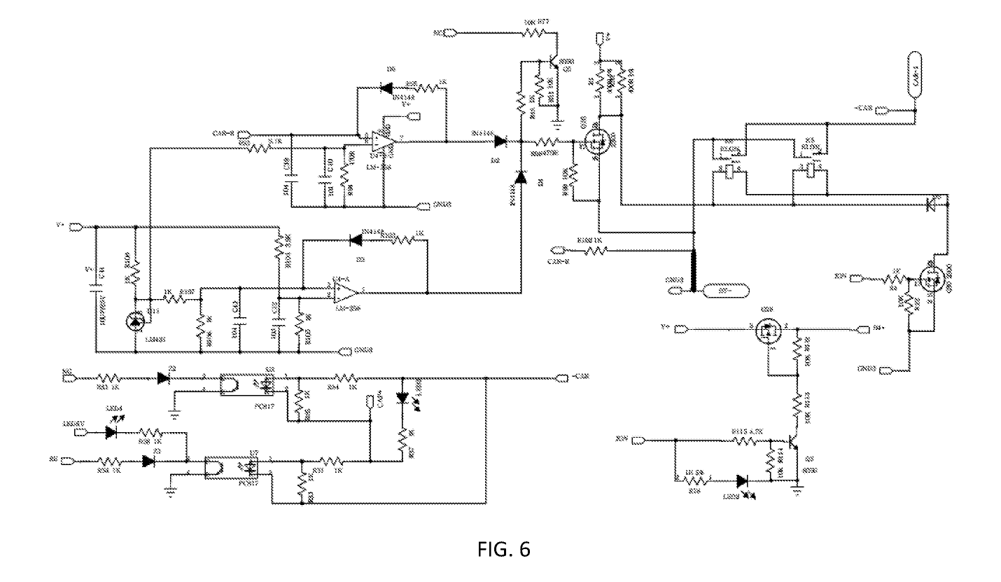

The schematic diagram of the circuit of the car battery bridging and protection module is shown in FIG. 6. The car battery bridging and protection module has output ports of positive and negative electrodes used for connecting the ignition clip of the car battery. The module is able to determine whether the car battery is present and whether the ignition clip of the car battery is correctly connected to the corresponding positive and negative electrodes of the car battery. The module further comprises the under-voltage, over-current and counter-charge protection of the lithium-ion battery. The design of under-voltage, over-current and counter-charge protection of the lithium-ion batteries uses the combination of a number of parallel MOSFETs or relays and diodes (D9 D10 D11 D12). Wherein the U7 photoelectric coupler PC817 is a detector used for determining whether the positive and negative electrodes of the car battery are connected correctly; when the positive and negative electrodes of the ignition clip of the car battery, which are connected to the output ports of the positive and negative electrodes of the car battery bridging and protection system, are correctly connected with the corresponding positive and negative electrodes of the car battery, that is, the red clip is connected to the positive electrode of the car storage battery while the black one is connected to the negative electrode of the car storage battery, the U7 is powered on to work and the LED4 is lit; when the MCU RE pin detects a low-level current, the microprocessor's MCU JON pin outputs a high-level current to start the ignition. The U3 photoelectric coupler PC817 is a detector used for determining the wrong connection of the car storage battery; when the product's ignition clip is incorrectly connected with the car storage battery, that is, the red clip is connected to the negative electrode of the car storage battery while the black one is connected to the positive electrode of the car storage battery, the U3 is powered on to work and the LED3 is lit; when the MCU NG pins detects a low-level current, the MCU controls the buzzer to sound an alarm (the sound can be adjusted by means of a software). The LM358 acts as a comparator; when the LM358 5 pin input detects the ignition current is higher than 600 A (it can be adjusted according to actual needs), the LM358 7 pin outputs a high-level current to turn off the ignition; when the MCU detects the NG pin is pulled to the ground, the software JON remains at a low level and the buzzer sounds an alarm for the ignition NG. The LM358 acts as a comparator; when the LN358 2 pin detects that the voltage of the product's battery is lower than 5V (it can be adjusted according to actual needs), the LM358 1 pin outputs a high-level current to turn off the ignition; when the MCU detects the NG pin is pulled to the ground, the software JON remains at a low level and the buzzer sounds an alarm for the ignition NG.

Preferably, the BMS comprises a BM3451-series chip which can realize a function of over-current, over-voltage and under-voltage, as well as temperature protection of the lithium-ion batteries.

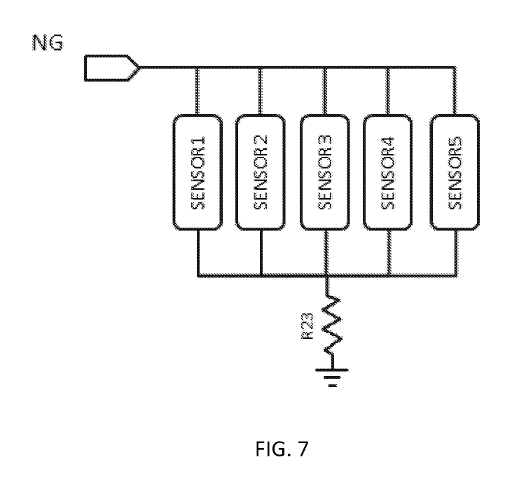

As shown in FIG. 7, the lithium-ion battery deformation detection sensing module comprises five deformation sensors which are connected in parallel and arranged in array on the surface of the cell of the lithium-ion battery. As shown in FIG. 1, the portable start-up power supply comprises a temperature detection module, wherein one end of the temperature detection module is connected with the lithium-ion battery and the other end is connected with the MCU microprocessor.

The embodiment described above is a preferred embodiment of the present invention, but it is not intended to limit the scope of the practical implementation of the invention. The scope of the present invention includes the embodiment but is not limited to it, and all equivalent changes in accordance with the morphology and structure of the present invention should be included within the scope of the present invention.

1. A portable start-up power supply comprising:
Supercapacitors;
lithium-ion batteries;
a supercapacitor precharge module;
a parallel switch module;
a battery management system (BMS);
a charging module;
a controller;
a switch; and
a car battery bridging and protection module,
wherein the controller is connected with the charging module, the BMS, the supercapacitor precharge module, the parallel switch module, the supercapacitors, the car battery bridging and protection module and the switch,
the charging module is connected with the BMS which is connected with the lithium-ion batteries,
the positive electrode of the lithium-ion battery is connected with the positive electrode of the supercapacitor through the supercapacitor precharge module, and the negative electrode of the lithium-ion battery is connected with the negative electrode of the supercapacitor,
the supercapacitor is connected with the car battery bridging and protection module, and
the parallel switch module is connected with the positive electrode of the lithium-ion battery and the positive electrode of the supercapacitor.

2. The portable start-up power supply according to claim 1, wherein the supercapacitor precharge module comprises a step-down charging circuit and a supercapacitor voltage detection circuit,
wherein the input terminal of the step-down charging circuit is connected with the positive electrode of the lithium-ion battery, the output terminal of the step-down charging circuit is connected with the positive electrode of the supercapacitor, the supercapacitor voltage detection circuit is connected with the output terminal of the step-down charging circuit, and the step-down charging circuit and the supercapacitor voltage detection circuit are connected with the controller,
the switch comprises a supercapacitor charging switch which is connected with the controller.

3. The portable start-up power supply according to claim 1, wherein the portable start-up power supply comprises a lithium-ion battery deformation detection sensing module, the lithium-ion battery deformation detection sensing module is connected with the surface of the lithium-ion battery, the lithium-ion battery deformation detection sensing module is connected with the controller.

4. The portable start-up power supply according to claim 3, wherein the portable start-up power supply comprises a temperature detection module, wherein one end of the temperature detection module is connected with the lithium-ion battery and the other end is connected with the controller.

5. The portable start-up power supply according to claim 3, wherein the portable start-up power supply comprises a USB interface and/or a DC interface, wherein one end of the USB interface and/or the DC interface is connected with the controller, and the other end of the USB interface and/or the DC interface is connected with the BMS.

6. The portable start-up power supply according to claim 3, wherein the controller comprises an MCU unit.

7. The portable start-up power supply according to claim 3, wherein the lithium-ion battery is a battery pack comprising four or seven single lithium-ion batteries in series.

8. The portable start-up power supply according to claim 3, wherein the supercapacitors comprise a supercapacitor pack composed of at least three supercapacitors connected in series and/or in parallel.

9. The portable start-up power supply according to claim 3, wherein the parallel switch module comprises at least two relays or MOS transistors, the at least two relays or the MOS transistors are connected in parallel.

10. The portable start-up power supply according to claim 3, further comprising an LED light and a buzzer, wherein the LED light and the buzzer are connected with the BMS respectively.

11. The portable start-up power supply according to claim 2, wherein the portable start-up power supply comprises a lithium-ion battery deformation detection sensing module, the lithium-ion battery deformation detection sensing module is connected with the surface of the lithium-ion battery, the lithium-ion battery deformation detection sensing module is connected with the controller.

12. The portable start-up power supply according to claim 11, wherein the portable start-up power supply comprises a temperature detection module, wherein one end of the temperature detection module is connected with the lithium-ion battery and the other end is connected with the controller.

13. The portable start-up power supply according to claim 11, wherein the portable start-up power supply comprises a USB interface and/or a DC interface, wherein one end of the USB interface and/or the DC interface is connected with the controller, and the other end of the USB interface and/or the DC interface is connected with the BMS.

14. The portable start-up power supply according to claim 11, wherein the controller comprises an MCU unit.

15. The portable start-up power supply according to claim 11, wherein the lithium-ion battery is a battery pack comprising four or seven single lithium-ion batteries in series.

16. The portable start-up power supply according to claim 11, wherein the supercapacitors comprise a supercapacitor pack composed of at least three supercapacitors connected in series and/or in parallel.

17. The portable start-up power supply according to claim 11, wherein the parallel switch module comprises at least two relays or MOS transistors, the at least two relays or the MOS transistors are connected in parallel.

18. The portable start-up power supply according to claim 11, further comprising an LED light and a buzzer, wherein the LED light and the buzzer are connected with the BMS respectively.
